(19) United States
(12) Patent Application Publication
(10) Pub. No.: US 2026/0340208 A1
(43) Pub. Date: Oct. 29, 2026

(54) METHOD OF GENERATING A COMPONENT INCLUDING A BLENDED LATTICE

(71) Applicant: Siemens Industry Software Inc., Plano, TX (US)

(72) Inventor: James Gunton, Cambridge (GB)

(21) Appl. No.: 19/110,194

(22) PCT Filed: Sep. 30, 2022
(86) PCT No.: PCT/US2022/045344

§ 371 Date: Mar. 10, 2025

(51) Int. Cl. G06F 30/10

(52) U.S. Cl. CPC G06F 30/10

(57) ABSTRACT

A computer-implemented method of generating a model of a component from a blended lattice is described. A piecewise scalar field function for a blended lattice, h(p), is evaluated as part of a marching cubes methodology. Away from any blends ƒ(p)=0 and g(p)=0 are the same iso-surface, where ƒ(p) is the field function of an unblended lattice and g(p) is the field function of a blended lattice. The value of h(p) at a position p, for two closest lattice topologies i₁, i₂, ƒ₁(p) and ƒ₂(p) satisfy ƒ₁(p)≤ƒ₂(p), is given by:

h(p)=ƒ(p) if ƒ₁(p)≤−v;

h(p)=ƒ(p) if ƒ₂(p)≥2r+v;

h(p)=ƒ(p) if ƒ₁(p)+ƒ₂(p)≥2r and ƒ₁(p)≥v;

h(p)=g(p) otherwise,
where r is the blend radius. A model of a component including the blended lattice with the scalar field function h(p) is then generated.

The present patent document is a § 371 nationalization of PCT Application Serial No. PCT/EP2022/045344, filed Sep. 30, 2022, designating the United States, which is hereby incorporated by reference in its entirety.

### TECHNICAL FIELD

The present disclosure relates to a computer-implemented method of generating a model of a component from a blended lattice, wherein the blended lattice includes a plurality of lattice topologies joined together.

### BACKGROUND

Computer-Aided Design (CAD) systems are used commonly in many fields of engineering, manufacturing, and design to create and manipulate solid modelling representations of objects, for example, in additive manufacturing. Boundary representation (B-rep) technology dominates CAD modelling. The B-rep technology provides an efficient and adaptable representation of parts by combining classic geometry: analytic surfaces and curves, non-uniform rational basis spline (NURBS), and procedural surfaces and curves; with topology, which captures the connectivity and interaction between geometric elements. Additive manufacturing is the process of creating three-dimensional objects using a three-dimensional printer based on CAD or other digital three-dimensional models. Objects may be scanned as a precursor to creating a CAD model, or may be designed from scratch, and stored in either STL (stereolithography file format) or AMF (additive manufacturing file format) files for future printing. Lattices are a common type of interior space-filler used in additive manufacturing as their lightweight, yet rigid construction makes them ideal for this purpose—the object is strengthened but its mass density remains relatively low. In B-rep (Boundary Representation) modelling, such spaces are enclosed by closed, connected sets of faces, where each face is a portion of a two-dimensional surface. The faces have boundary edges, which are defined by curves where the faces intersect with one another. Lattices include a plurality of lattice topologies, where a lattice topology is either a rod or a ball. Rods may be cylindrical or conical, and balls are spherical. Each rod is joined to other rods by a ball, building up the lattice structure.

Complex lattice structures may be used in heat transfer, filtration, and structural components for their energy absorption, mechanical strength, and other physical qualities, which have a broad range of application from automotive to medical technology sectors. One particular issue with a lattice structure, however, is the occurrence of stress at the points where the rods and balls intersect. This may be caused by a sharp, concave edge being generated in the lattice surface. Stress points are problematic as they lead to issues with the lattice structure deforming or even breaking apart in a final component. For example, if the intersection between a rod and ball is a region of high stress, then little mechanical strength or pressure will be required to cause the lattice to break at the intersection. One solution to this is to create a blended lattice structure, where intersections between rods and balls within the lattice have a smoothed surface, thus removing concave sharp edges and the origin of regions of stress. An example of a blend is shown in FIG. 1a, which is a schematic perspective view of four rods joined at one ball with a blended surface. The four rods 1, 2, 3, 4 meet a ball 5, which is no longer seen due to the blended surface, which effectively obscures the intersection points between the rods 1, 2, 3, 4 and the ball 5. The upper blended surface 6, in plane with the long axes of the rods 1, 2, 3, 4 is shown to be smoothed with only a small, rounded ridge corresponding to each rod 1, 2, 3, 4, visible. Although not seen, the same is view for the lower blended surface 7. Between each of the rods 1, 2, 3, 4, the upper blended surface 6 and the lower blended surface are stretched into webbed sections 8, 9, 10, 11, where the upper blended surface 6 and the lower blended surface 7 meet. This creates smooth surfaces between each of the four rods 1, 2, 3, 4.

However, one issue with available blending applications is that too much material may be added at the intersection point, leading to bulging. This is illustrated in FIG. 1b, which is a schematic perspective view of four rods joined at one ball with a bulged blended surface. Rather than the smooth upper blended surface 6 seen in FIG. 1a, a significant bulge 12 is visible at the intersection point. This causes the box size, in model space, of the incarnated blended lattice to be greater than the box size of the incarnated unblended lattice, which may (i) create interference problems when incorporated into an assembly containing other components, and (ii) cause the calculation of the box to be more computationally intensive. Additional material is added to flat or convex surfaces, whereas the surface of interest for smoothing is the sharp concave edges between lattice topologies.

A second issue is the freedom of a user to select the level of blending at each lattice intersection. Blending is specified using a blend radius, which is a value representing the amount of material added at each intersection point. The blend radius in existing blending applications is constant, such that the same blend is applied at every intersection point of the lattice. However, in some applications it may be necessary to add differing amounts of material depending on the desired characteristics of the final model or product. For example, a heat sink may need different thermal properties in different locations, or a component may require different mechanical strengths in certain areas. Such options are not possible without being able to change the blend radius at different positions in the lattice.

There is therefore a need for an improved method of generating a component from a blended lattice that takes into account the issues encountered by bulging, constant radius blends.

### SUMMARY

The present disclosure aims to address these issues, by providing, in a first aspect, a computer-implemented method of generating a model of a component from a blended lattice, wherein the blended lattice includes a plurality of lattice topologies joined together. The method includes: a) dividing the volume containing the input lattice into a plurality of cubes, each cube (or “voxel”) having side length v (the “voxel resolution”); b) evaluating h(p) uniformly over the volume for each value of a position p occurring at the corner of a cube, wherein h(p) is the piecewise scalar field function for a blended lattice; wherein the surface of an unblended lattice is defined by the field function ƒ(p) and the surface of a blended lattice is defined by the field function g(p), wherein away from any blends ƒ(p)=0 and g(p)=0 are the same iso-surface, and wherein the value of h(p) at a position p wherein for the two closest lattice topologies i₁, i₂, ƒ₁(p) and ƒ₂(p) satisfy ƒ₁(p)≤ƒ₂(p) is given by:

h(p)=ƒ(p) if ƒ₁(p)<−v;

h(p)=ƒ(p) if ƒ₂(p)≥2r+v;

h(p)=ƒ(p) if ƒ₁(p)+ƒ₂(p)≥2r and ƒ₁(p)≥v;

h(p)=g(p) otherwise,

where r is the blend radius; and c) generating a model of a component including a blended lattice with the scalar field function h(p).

By integrating a piecewise calculation of the scalar field function h(p) for a blended lattice into a marching cubes approach and making use of the ability to equate h(p) to the field function for an unblended lattice ƒ(p) for values of position p outside of a boundary set by the voxel resolution v and the blend radius r, the embodiments disclosed herein offer an accurate blending process that avoids adding additional material in flat or convex regions. In addition, the need to determine the field function in the blend region g(p) for only a relatively small number of values of position p and relying on the faster calculation of the unblended lattice field function ƒ(p) reduces the calculation time, thus providing a more controllable final component in a manufacturing or design process in a shorter time.

Each lattice topology i may be a rod or a ball.

The field function of the unblended lattice ƒ(p) may be given by:

$$f ( p ) = {min}_{1 \leq i \leq N} {f}_{i} ( p )$$

where ƒᵢ(p) is the signed distance from the position p to the surface of a lattice topology i, and N is the number of lattice topologies in the lattice; and wherein the field function of the blended lattice g(p) is given by:

$$g ( p ) = {max}_{‖ q - p ‖ \leq r} ( f ( q ) - r )$$

where q is a position within the volume of a sphere of radius r centered at p.

The evaluation of:

$$f ( p ) = {min}_{1 \leq i \leq N} {f}_{i} ( p )$$

may be stopped at a value of i where ƒᵢ(p)≤−v, and the evaluation of:

$$g ( p ) = {max}_{‖ q - p ‖ \leq r} ( f ( q ) - r )$$

is stopped at a value of q where ƒ(q)−r≥v.

If the value of h(p′) has already been calculated at a position p′, the value of h(p) may be set to a lower bound:

h_{lower}=h(p′)−∥p−p′∥, when h_{lower}≥v

or to an upper bound:

hᵤₚₚₑᵣ=h(p′)+∥p−p′∥, when hᵤₚₚₑᵣ≤−v.

In one option, g(p) and the corresponding position q may be determined exactly. Alternatively, g(p) and the corresponding position q may be estimated. Yet further alternatively, g(p) and the corresponding position q may be determined using sampling of the sphere.

The blend radius r may be constant over the lattice structure. Alternatively, the blend radius r may be a function of the position p.

The method may further include incarnating the blended lattice as a mesh surface prior to generate the model of the component. The method may further include exporting the model of the component to an additive manufacturing device and manufacturing the component.

In a second aspect, a data processing system configured to generate a model of a component from a blended lattice is provided, wherein the blended lattice includes a plurality of lattice topologies joined together. The data processing system includes a processor configured to: divide the volume containing the input lattice into a plurality of cubes, each cube (or “voxel”) having side length v (the “voxel resolution”); evaluate h(p) uniformly over the volume for each value of a position p occurring at the corner of a cube, wherein h(p) is the piecewise scalar field function for a blended lattice; wherein the surface of an unblended lattice is defined by the field function ƒ(p) and the surface of a blended lattice is defined by the field function g(p), wherein away from any blends ƒ(p)=0 and g(p)=0 are the same iso-surface, and wherein the value of h(p) at a position p wherein for the two closest lattice topologies i₁, i₂, ƒ₁(p) and ƒ₂(p) satisfy ƒ₁(p)≤ƒ₂(p) is given by:

h(p)=ƒ(p) if ƒ₁(p)≤−v;

h(p)=ƒ(p) if ƒ₂(p)≥2r+v;

h(p)=ƒ(p) if ƒ₁(p)+ƒ₂(p)≥2r and ƒ₁(p)≥v;

h(p)=g(p) otherwise,

where r is the blend radius; and generate a model of a component including a blended lattice with the scalar field function h(p).

The data-processing system may further include an output to a three-dimensional printing device.

In a third aspect, a computer program is provided, which, when executed on a computer, causes the computer to carry out the acts of the method outlined above.

### BRIEF DESCRIPTION OF THE DRAWINGS

The present disclosure is now described by way of example only, and with reference to the accompanying drawings, in which:

FIG. 1a is a schematic perspective view of four rods joined at one ball with a blended surface;

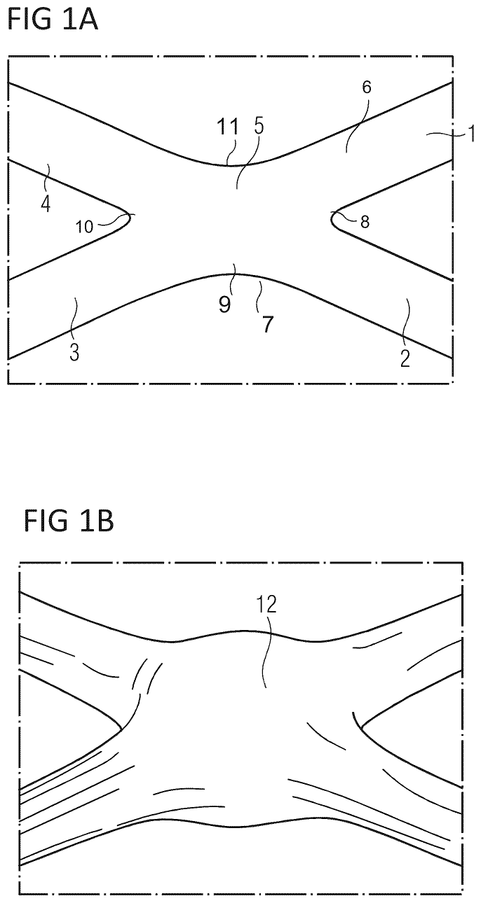

FIG. 1b is a schematic perspective view of four rods joined at one ball with a bulged blended surface;

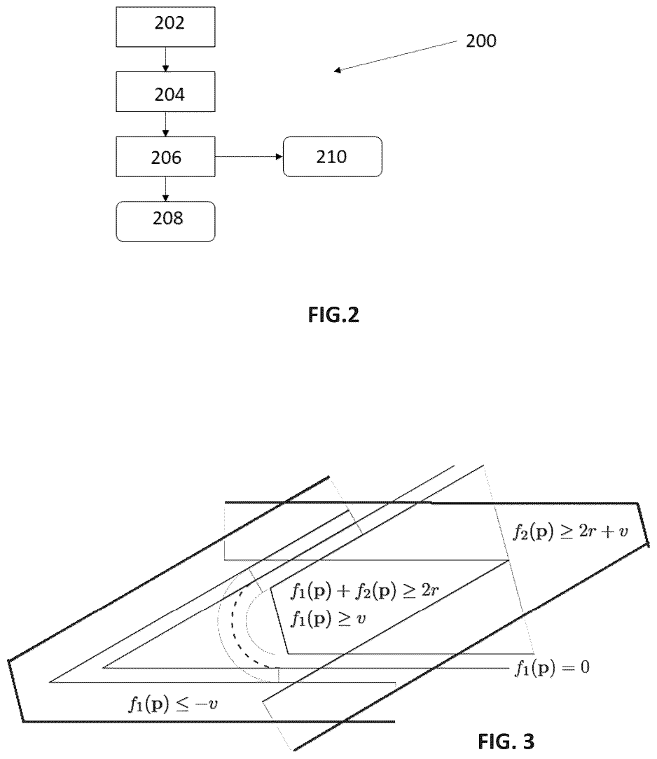

FIG. 2 is a flowchart of a method in accordance with an embodiment;

FIG. 3 is a schematic representation of two lattice topologies at a sharp concave edge;

FIG. 4 is a schematic illustration of a series cross-sections of iso-surfaces of ƒ(p) and g(p);

FIG. 5 is a schematic representation of finding an exact maximum over a sphere;

FIG. 6 is a schematic representation of estimating a maximum over a sphere;

FIG. 7 is a schematic illustration of measurements on a triangular face on the surface of a sphere;

FIG. 8 illustrates an example of a data processing system in which an embodiment of the present disclosure may be implemented, for example a CAD system configured to perform processes as described herein;

FIGS. 9 to 23 each show a pair of lattices, where (i) in FIGS. 9-23 is the unblended lattice and (ii) in FIGS. 9-23 is the blended lattice generated using the methods of the embodiments.

### DETAILED DESCRIPTION

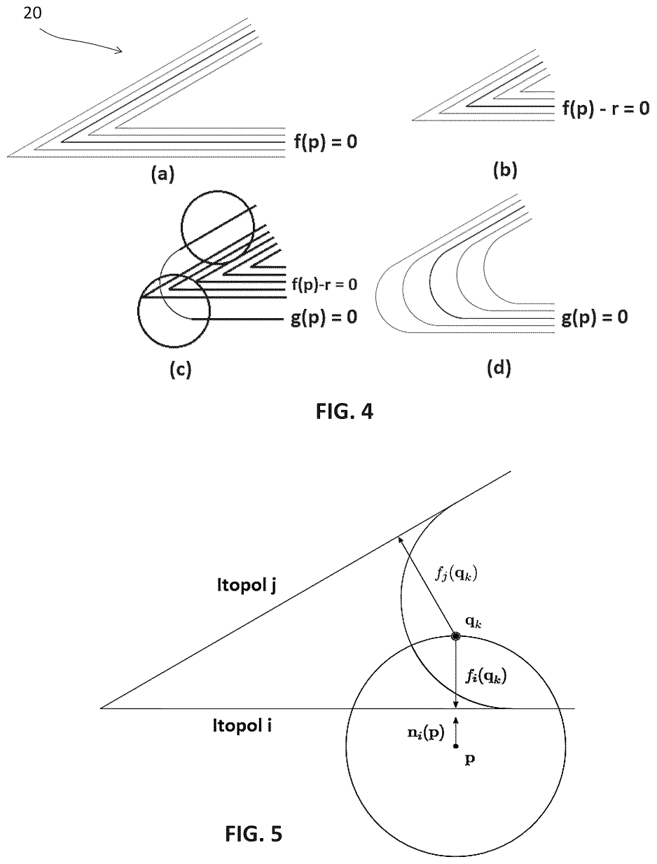

Embodiments of the present disclosure take the approach of using a rolling ball blending method to deal with sharp concave edges in lattice structures without adding bulging at lattice intersections. FIG. 2 is a flowchart of a method in accordance with an embodiment. The method 200 generates a model of a component from a blended lattice, where the blended lattice includes a plurality of lattice topologies joined together. Initially, at act 202, the volume containing the input lattice is divided into a plurality of cubes, each cube (or “voxel”) having a side length v (the “voxel resolution”). Then, at act 204, h(p) is evaluated uniformly over the volume for each value of a position p occurring at the corner of a cube, where h(p) is the piecewise scalar field function for a blended lattice. The surface of an unblended lattice is defined by the field function ƒ(p) and the surface of a blended lattice is defined by the field function g(p). Away from any blends, ƒ(p)=0 and g(p)=0 are the same iso-surface. The value of h(p) at a position p wherein for the two closest lattice topologies i₁, i₂, ƒ₁(p) and ƒ₂(p) satisfy ƒ₁(p)≤ƒ₂(p) is given by:

h(p)=ƒ(p) if ƒ₁(p)≤−v;

h(p)=ƒ(p) if ƒ₂(p)≥2r+v;

h(p)=ƒ(p) if ƒ₁(p)+ƒ₂(p)≥2r and ƒ₁(p)≥v;

h(p)=g(p) otherwise,

where r is the blend radius.

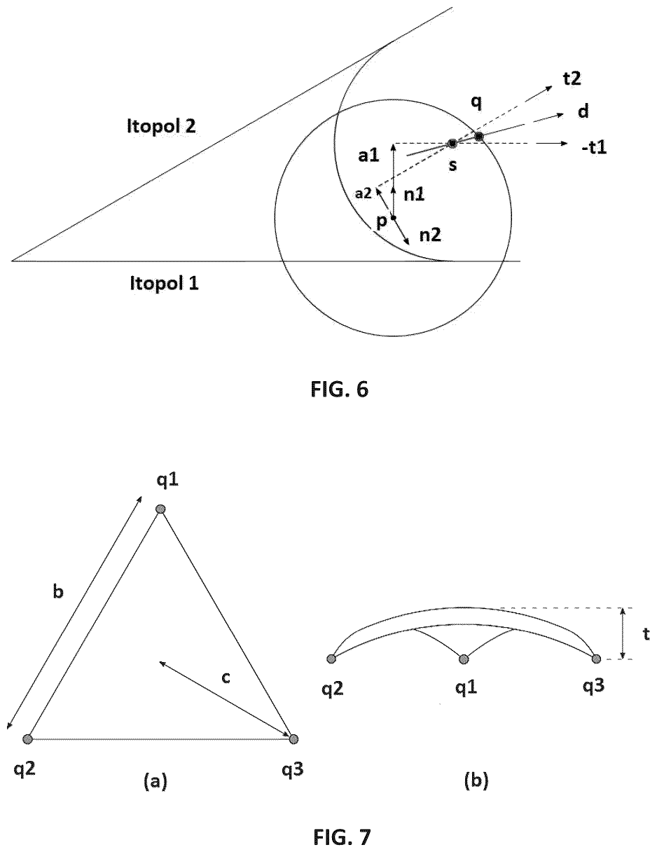

At act 206, a model of a component is generated including a blended lattice with the scalar field function h(p). The method 200 may also include optional acts, depending on the purpose of the component. At act 208, the blended lattice may be incarnated as a mesh surface prior to generate the model of the component. At act 210, the model of the component may be exported to an additive manufacturing device and manufacturing the component. The mathematical relationships above are represented schematically in FIG. 3, which is a schematic representation of two lattice topologies at a sharp concave edge. The acts of the method 200 are described in more detail below.

A blended lattice surface is defined by the scalar field function h(p)=0 for positions p, with h(p)<0 inside the lattice surface and h(p)>outside the lattice surface. Far enough from any blends, the scalar field function h(p) equals the field function of the unblended lattice, ƒ(p). Near the blends, h(p) equals a blended field function g(p), which is based on an offsetting function for constant radius blending described in “Blending Operations for the Functionally Based Constructive Geometry,” Alexander A, Pasko and Vladimir V. Savchenko, Set Theoretic Solid Modelling: Techniques and Applications, CSG 94 Conference Proceedings. For a lattice containing only sharp concave edges, blending takes place by offsetting the lattice outwards by the blend radius r, and then offsetting inwards, creating rolling-ball blends. The blend radius r may be a constant across the lattice, or a function of position that varies across the lattice. Embodiments of the present disclosure that deal with the generation of a component from a blended lattice with a constant blend radius r is now described.

### Unblended and Blended Field Functions

The field function representing the signed distance from a position p to the surface of a lattice topology i, such as a rod, is fᵢ(p), which has a value of 0 at the lattice topology surface and is positive outside the lattice topology surface and negative inside the lattice topology surface. The field function of the unblended lattice that contains N lattice topologies is constructed as the union of N lattice topologies, ƒ(p) is given by:

$$f ( p ) = {min}_{1 \leq i \leq N} {f}_{i} ( p )$$

After blending with blend radius r, the blended field function g(p) is given by:

$$g ( p ) = {max}_{‖ q - p ‖ \leq r} ( f ( q ) - r )$$

where q is a position within the volume of a sphere of radius r centered at p.

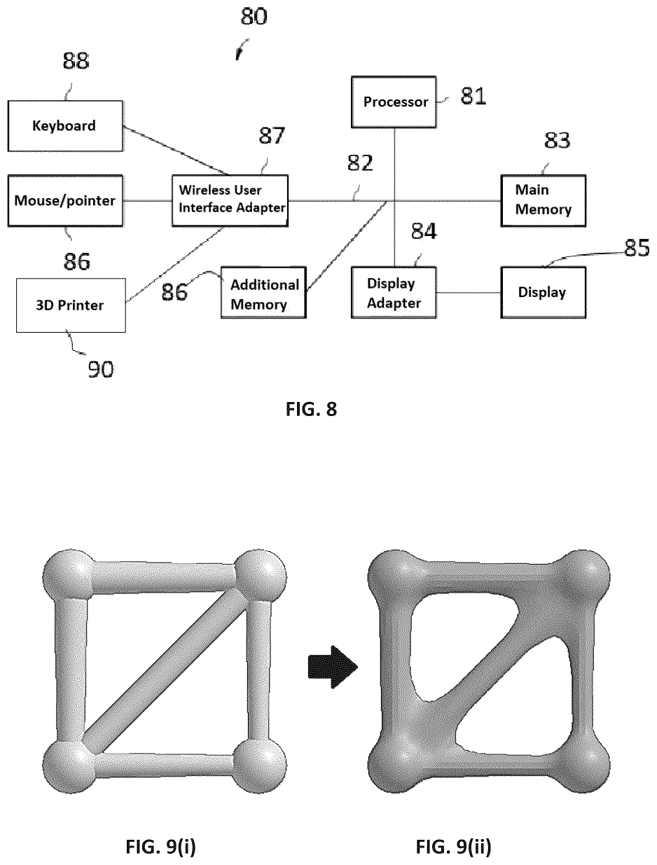

FIG. 4 is a schematic illustration of a series cross-sections of iso-surfaces of ƒ(p) and g(p). Each field function is positive outside of the lattice, zero on the surface of the lattice and negative inside the lattice. FIG. 4a illustrates the field function at ƒ(p)=0, where the central line 20 is the surface of the unblended lattice. FIG. 4b illustrates the situation where the field function minus the blend radius is zero, or ƒ(p)−r=0. The blend may be considered as a set of points traced out by the center of a solid ball 21 having a radius equal to the blend radius r, which is rolled around the inside of an offset lattice, where the offset lattice is the unblended lattice expanded by the blend radius r. The center of the ball represents the field function g(p)=0, and the surface of the ball 21 remains continuously in contact with the iso-surface at ƒ(p)−r=0, as shown in FIG. 4c. Finally, FIG. 4d illustrates the field function at g(p)=0. The function value equals the distance to the lattice surface only in some regions, for example, g(p) may be several times smaller than the distance to the blend surface when the unblended lattice has a very sharp edge. It is necessary to find the maximum value of ƒ(q)−r over the volume of the sphere (∥q−p∥≤r) rather than over the surface of the sphere (∥q−p∥=r). If at any point the maximum value over the surface is negative but the maximum value over the volume is positive, and only the surface maximum is used the blend surface will contain unwanted disconnected elements. This may only happen if the offset lattice contains void regions, which may occur even when the unblended lattice does not contain any void regions.

### Combining the Unblended and Blended Field Functions

Calculating the blended field function g(p) is slower than calculating the unblended field function ƒ(p), because this may require sampling to find the maximum value. As mentioned above, away from any blended regions, both ƒ(p) and g(p) have the same iso-surface (where ƒ(p)=g(p)=0), hence it is possible to use ƒ(p) in these regions instead of g(p) to determine the scalar field function for the blended lattice h(p). This is possible at a position p wherein for the two closest lattice topologies i₁, i₂, ƒ₁(p) and ƒ₂(p) satisfy ƒ₁(p)≤ƒ₂(p) is given by:

h(p)=ƒ(p) if ƒ₁(p)≤−v;

h(p)=ƒ(p) if ƒ₂(p)≥2r+v;

h(p)=ƒ(p) if ƒ₁(p)+ƒ₂(p)≥2r and ƒ₁(p)≥v;

h(p)=g(p) otherwise,

where r is the blend radius.

When using a marching cubes algorithm such that the entire lattice volume is divided into cubes, each cube (or “voxel”) having side length v (the “voxel resolution”). A spatial tree is used to efficiently find all of the lattice topologies within 2r+v of the position p. If fewer than two lattice topologies are found within this distance, then the condition for the second case for h(p) is met. If there are no lattice topologies, then h(p)=ƒ(p)>2r+v. Both ƒ(p) and g(p) are G⁰ continuous (where G⁰ is the first order of surface continuity such that two surfaces meet along a common edge forming a watertight boundary), but h(p) is not. However, none of the G⁰ discontinuities are within the voxel resolution of the blend surface, so they do not affect the blend surface.

### Approximating Field Values

The marching cubes algorithm estimates the position of the lattice surface by estimating the zero-crossing point along each cube edge, of length v, which connects a corner with a positive value to a corner with a negative value. The only positions p whose field values affect the position of the lattice surface are those that are within the voxel resolution v of the surface. Any other positions p may be given field values that bear little or no relation to h(p), as long as the values are ≥v outside the surface or ≤−v inside the surface. This allows the following performance improvements to be used:
The evaluation of

$$f ( p ) = {min}_{1 \leq i \leq N} {f}_{i} ( p )$$

may be stopped as soon as a lattice topology is found that satisfies ƒᵢ(p)≤v, such that p is sufficiently far inside the unblended lattice;
The evaluation of

$$g ( p ) = {max}_{‖ q - p ‖ \leq r} ( f ( q ) - r )$$

may be stopped as soon as a point q is found that satisfies ƒ(q)−r≥v (such that p is sufficiently far outside the blended lattice);
If the value of h(p′) has already been calculated at a position p′, the value of h(p) may be set to a lower bound h_{lower}=h(p′)−∥p−p′∥ if h_{lower}≥v or to an upper bound hᵤₚₚₑᵣ=h(p′)+∥p−p′∥ if hᵤₚₚₑᵣ≤−v.

For the last point to be true it is assumed that |h(p′)| is no larger than the absolute distance d from p′ to the blended lattice, which is the case given that |ƒ(p′)|≤d and |g(p′)|≤d and given that |h(p′)| decreases by ∥p₂−p₁∥≥d₂−d₁ through successive uses of the lower or upper bounds.

### Finding the Exact Maximum Value Over the Sphere

The equations for ƒ(p) and g(p) may be rearranged to form the inequality:

$$f ( {q}_{k} ) - r \leq {max}_{‖ q - p ‖ \leq r} ( f ( q ) - r ) \leq {max}_{‖ q - p ‖ \leq r} ( {f}_{i} ( q ) - r )$$

for a particular sample point qₖ and lattice topology i.

The outer two values are easier to calculate than the middle value, g(p). If qₖ and i may be found so that the outer two values are equal, then this gives an exact value for g(p). For the lattice topology i, the right-hand value is:

$${max}_{‖ q - p ‖ \leq r} ( {f}_{i} ( q ) - r ) = {f}_{i} ( {q}_{k} ) - r$$

with:

qₖ=p+rnᵢ(p)

where nᵢ(p) is the gradient of ƒᵢ(p), the normalized direction from the lattice topology i to position p if p is outside the lattice topology i, or in the reverse direction if p is inside.

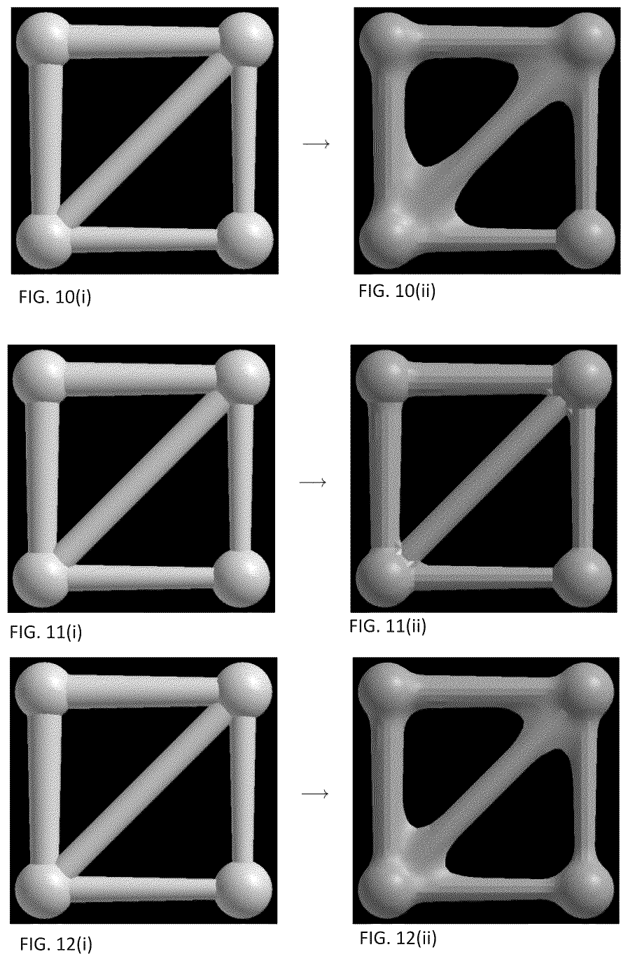

The right-hand value equals the left-hand value if there are not lattice topologies closer to qₖ than the lattice topology i, in which case g(p)=ƒ(p). This may be the case if the lattice topology closest to p is chosen. This is shown schematically in FIG. 5.

### Estimating the Maximum Value

By ignoring all lattice topologies except two, and by approximating those lattice topologies as planar, an estimate may be found for the blend spine positions s and the direction of steepest increase of ƒ(p). This is done using the distance to each lattice topology ƒ_{1,2}(p) and the field gradients of each lattice topology n_{1,2}(p), so long as the normal of the cross-section plane, N=n₁(p)×n₂(p), is not a zero vector. The spine s is the intersection of the two lines p+a_{1,2}+λt_{1,2}, where

t_{1,2}=n_{1,2}(p)×N

a_{1,2}=(r−ƒ_{1,2}(p))n_{1,2}(p)

The direction of steepest increase of ƒ(p) is:

d=n₁(p)+n₂(p)

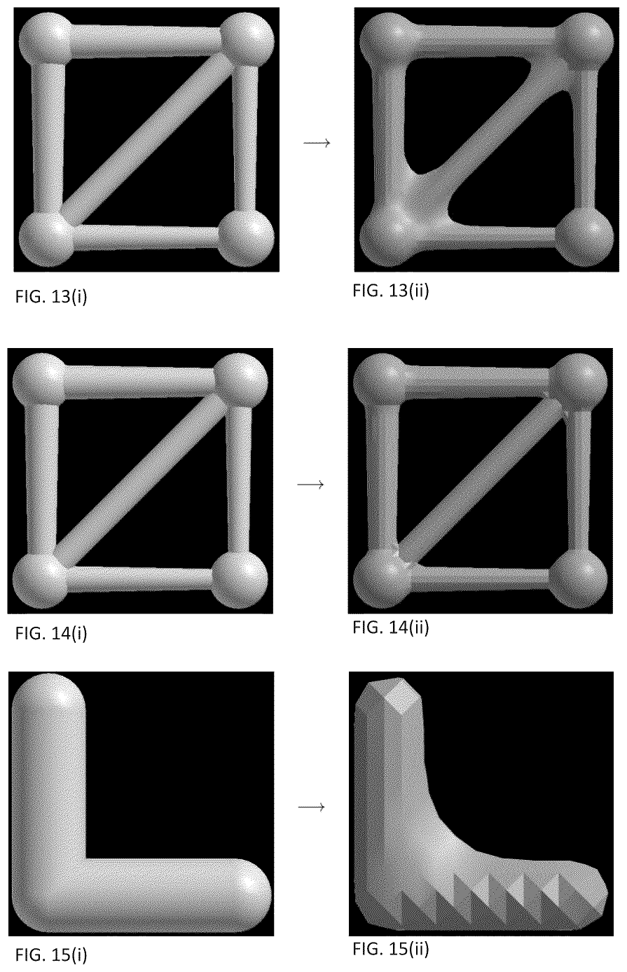

Intersecting the line s=μd with the sphere centered at p and using the solution with the larger d component, or using the closest approach if the line does not intersect the sphere, gives a position q. If the closest two lattice topologies to the position p are used, then the position q is likely to give a near-maximum value for g(p), ignoring the curvature of the lattice topology and all other lattice topologies. This estimate may be used if it is larger than v. This is shown schematically in FIG. 6.

### Sampling the Sphere

If the shortcuts outlined above have not given a value for g(p), the sphere is sampled in order to estimate its value. The sampling density in certain portions of the sphere needs to be high in order to produce a smooth blend. Sampling may be performed over a maximum of nine stages, selectively increasing the sampling density, until g(p)≥v or, if there have been more than four stages, until the separation between sample points is less than the voxel resolution v. A sample is taken at the center of the sphere, and the samples are taken at the vertices of a series of geodesic polyhedra, constructed by subdividing faces of an icosahedron and projecting the vertices onto the sphere surface. The following acts are then carried out:

Make a list of the twenty faces of an icosahedron with vertices lying on the sphere of blend radius r and centered at position p.

For each face in the face list, and for each vertex q of this triangular face, calculate the value of ƒ(q)−r. Avoid any vertices already visited during this stage or earlier stages. Increase g(p) to ƒ(q)−r if it is higher than the current maximum. Stop if g(p) is greater than the voxel resolution v.

For each face in the face list, use its three vertices' sample values to decide whether the face may contain a higher value of ƒ(q)−r than the current maximum. If so, subdivide the face into smaller triangular faces, project the vertices onto the sphere and append these faces to the face list to be used in the next stage of refinement.

Repeat from act b using the next stage's face list, if it is not empty, e.g., for a maximum of nine stages, or, if there have been more than four stages, until the separation between sample points is less than the voxel resolution v.

All the stages' faces and vertices are calculated only once, and each stage's faces are ordered so that the n subdivisions of face Aᵢ are faces Bₙᵢ . . . Bₙᵢ₊ₙ₋₁, the n subdivisions of face Bᵢ are faces Cₙᵢ . . . Cₙᵢ₊ₙ₋₁, and so on. A single array may be used to store the sample values to be reused in later stages without recalculation. Experimentally, subdividing each face into four was found to give the best performance. A face may be subdivided if it is possible to contain a higher value of ƒ(q)−r than the current maximum. The highest value possible depends on the minimum and maximum values of Gᵢ at the face's vertices qᵢ (where Gᵢ=ƒ(qᵢ)−r) and the size of the face, given that ∥∇g∥≤1:

gᵤₚₚₑᵣ=min(max(G₁,G₂,G₃)+d,min(G₁,G₂,G₃)+b)

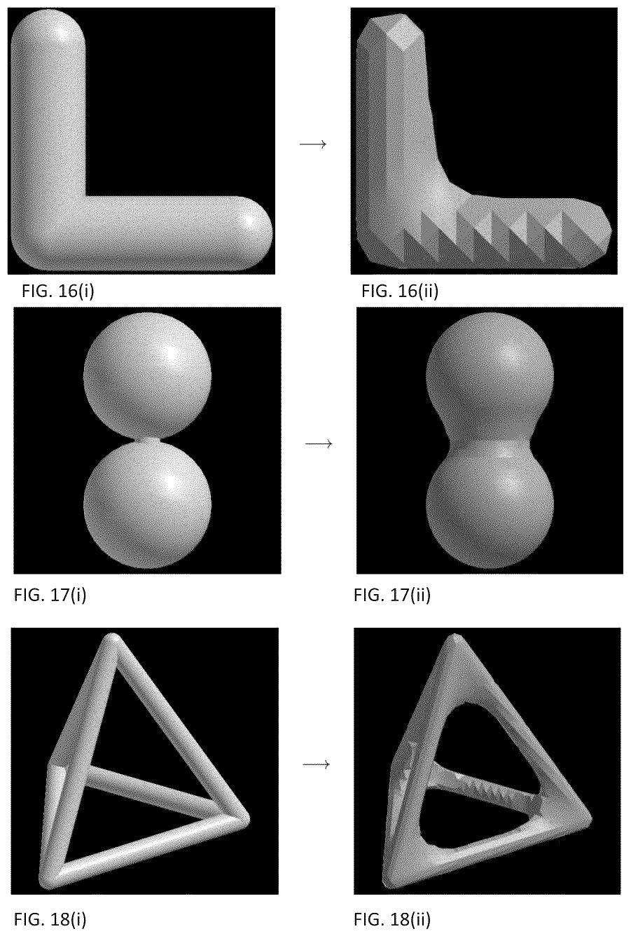

With d=t if the face's vertices each have the same closest lattice topology (giving a smaller upper bound), or d=c otherwise. b is the maximum separation of the face's vertices, c is the distance from the center of the spherical face to the vertices, and t is the thickness of the spherical face. This is shown schematically in FIG. 7, which illustrates the measurement of a triangular face on a sphere. b, c, and t are calculated for each face as the variation in value between faces within a stage may be significant, particular in the later stages. For example, in the sixth stage, b may vary by 24%, c may vary by 30% and t may vary by 84%.

### Variable Radius Blending

Embodiments of the present disclosure that deal with the generation of a component from a blended lattice with a variable blend radius r(p) is now described. Variable-radius blending may be achieved by letting the blend radius be a function of position r(p). The blend radius at position p is given by:

$$r ( p ) = \{ \begin{matrix}\frac{{\sum }_{i = 1}^{N} {w}_{i} ( p ) {r}_{i} ( p )}{{\sum }_{i = 1}^{N} {w}_{i} ( p )} & if {w}_{i} ( p ) \neq 0 for some i \\ 0 & if {w}_{i} ( p ) = 0 for all i\end{matrix}$$

$$where : {w}_{i} ( p ) = \{ \begin{matrix}1 & if {f}_{i} ( p ) \leq 0 \\ 1 - \frac{{f}_{i} ( p )}{2 {r}_{i} ( p )} & if 0 < {f}_{i} ( p ) < 2 {r}_{i} ( p ) \\ 0 & if {f}_{i} ( p ) \geq 2 {r}_{i} ( p )\end{matrix}$$

and where ƒᵢ(p) is the signed distance of position p outside the surface of the lattice topology i, and rᵢ(p) is the blend radius of the lattice topology i.

Each blend radius may be specified for each lattice ball either absolutely or relative to the lattice ball's radius. Each lattice ball's blend radius rᵢ(p) is independent of the position p, whereas a lattice rod's blend radius is linearly interpolated from the blend radii of its two lattice balls. The interpolation is done by relaxing from position p to the lattice rod surface and using the proportional distance of the relaxed point along the lattice rod. Replacing the constant blend radius r in the acts outlined above with a variable blend radius r(p) requires the use of the minimum rₘᵢₙ and maximum rₘₐₓ blend radii of the lattice balls. The lower and upper bounds h_{lower}=h(p′)−∥p−p′∥, hᵤₚₚₑᵣ=h(p′)+∥p−p′∥ are affected, as r(p) is not yet known, hence rₘᵢₙ and rₘₐₓ are used instead:

h_{lower}=h(p′)−max(∥p−p′∥,rₘₐₓ−r(p′)) if h_{lower}≥v

hᵤₚₚₑᵣ=h(p′)+max(∥p−p′∥,r(p′)−rₘᵢₙ) if hᵤₚₚₑᵣ≤−v

The spatial tree distance for finding all of the lattice topologies becomes 2rₘₐₓ+v, and the array of lattice topologies found is used to calculate r(p).

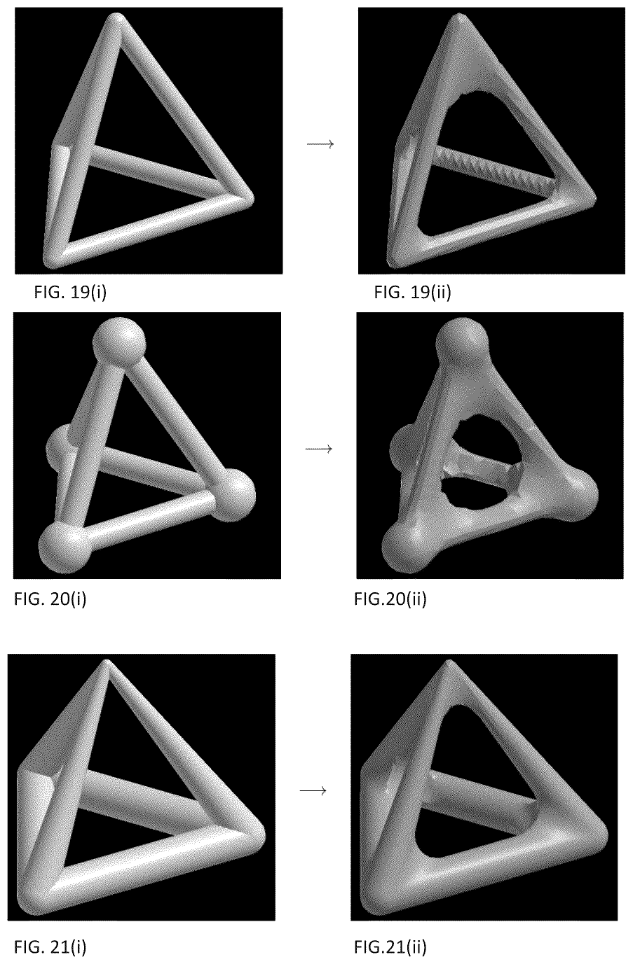

FIG. 8 illustrates an example of a data processing system in which an embodiment of the present disclosure may be implemented, for example, a CAD system configured to perform processes as described herein. The data processing system 80 includes a processor 81 connected to a local system bus 82. The local system bus connects the processor to a main memory 83 and graphics display adaptor 84, which may be connected to a display 85. The data processing system may communicate with other systems via a wireless user interface adapter connected to the local system bus 82, or via a wired network, for example, to a local area network. Additional memory 86 may also be connected via the local system bus. A suitable adaptor, such as wireless user interface adapter 87, for other peripheral devices, such as a keyboard 88 and mouse 89, or other pointing device, allows the user to provide input to the data processing system. An additive manufacturing device, such as a 3D printer 90 may be included to enable the model of the component to be exported for manufacture. Other peripheral devices may include one or more I/O controllers such as USB controllers, Bluetooth controllers, and/or dedicated audio controllers (connected to speakers and/or microphones). Various peripherals may be connected to the USB controller (via various USB ports) including input devices (e.g., keyboard, mouse, touch screen, trackball, camera, microphone, scanners), output devices (e.g., printers, speakers), or any other type of device that is operative to provide inputs or receive outputs from the data processing system. Further, certain devices referred to as input devices or output devices may both provide inputs and receive outputs of communications with the data processing system. Further, other peripheral hardware connected to the I/O controllers may include any type of device, machine, or component that is configured to communicate with a data processing system.

An operating system included in the data processing system enables an output from the system to be displayed to the user on display 85 and the user to interact with the system. Examples of operating systems that may be used in a data processing system may include Microsoft Windows™, Linux™, UNIX™, iOS™, and Android™ operating systems.

In addition, the data processing system 80 may be implemented as in a networked environment, distributed system environment, virtual machines in a virtual machine architecture, and/or cloud environment. For example, the processor 81 and associated components may correspond to a virtual machine executing in a virtual machine environment of one or more servers. Examples of virtual machine architectures include VMware ESCi, Microsoft Hyper-V, Xen, and KVM.

Those of ordinary skill in the art will appreciate that the hardware depicted for the data processing system 80 may vary for particular implementations. For example, the data processing system 80 in this example may correspond to a computer, workstation, and/or a server. However, alternative embodiments of a data processing system may be configured with corresponding or alternative components such as in the form of a mobile phone, tablet, controller board, or any other system that is operative to process data and carry out functionality and features described herein associated with the operation of a data processing system, computer, processor, and/or a controller discussed herein. The depicted example is provided for the purpose of explanation only and is not meant to imply architectural limitations with respect to the present disclosure.

The data processing system 80 may be connected to the network (not a part of data processing system 80), which may be any public or private data processing system network or combination of networks, as known to those of skill in the art, including the Internet. Data processing system 80 may communicate over the network with one or more other data processing systems such as a server (also not part of the data processing system 80). However, an alternative data processing system may correspond to a plurality of data processing systems implemented as part of a distributed system in which processors associated with several data processing systems may be in communication by way of one or more network connections and may collectively perform tasks described as being performed by a single data processing system. Thus, it is to be understood that when referring to a data processing system, such a system may be implemented across several data processing systems organized in a distributed system in communication with each other via a network.

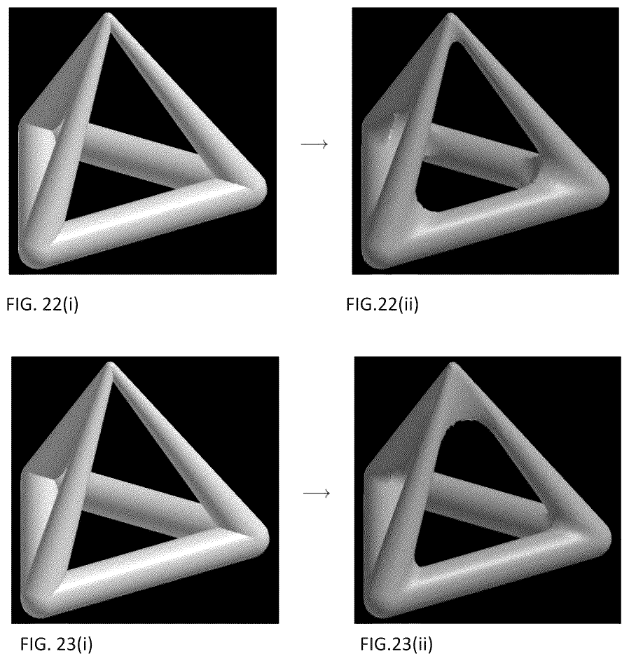

The embodiments provide blended lattices without the bulging at lattice intersections seen in existing blending applications. In addition, by using the shortcuts outlined above, the method is far quicker than if g(p) were to be evaluated for every cube voxel corner. This is illustrated in FIGS. 9 to 23 and summarized below. Each figure shows a pair of example lattices, where figure (i) is the unblended lattice and figure (ii) is the blended lattice:

| FIG. | Lattice Description | Type of Blend |
|---|---|---|
| 9 | Square lattice (rod and ball) | Absolute blend size, constant size |
| 10 | Square lattice (rod and ball) | Absolute blend size, variable size |
| 11 | Square lattice (rod and ball) | Absolute blend size, variable size |
| | | of 0 |
| 12 | Square lattice (rod and ball) | Relative blend size, constant size |
| 13 | Square lattice (rod and ball) | Relative blend size, variable size |
| 14 | Square lattice (rod and ball) | Relative blend size, variable size |
| | | of 0 |
| 15 | Perpendicular rods | Constant blend radius |
| 16 | Perpendicular rods | Variable blend radius |
| 17 | Short rod, two balls | Variable blend radius |
| 18 | Tetrahedron rods | Constant blend radius |
| 19 | Tetrahedron rods | Variable blend radius |
| 20 | Tetrahedron, rod and balls | Constant blend radius |
| 21 | Tetrahedron cone rods | Absolute blend size, constant size |
| 22 | Tetrahedron cone rods | Relative blend size, constant size |
| 23 | Tetrahedron cone rods | Absolute blend size, variable size |

In each example, an absolute blend size is one where the blend radius is independent of the radii of the lattice balls and a relative blend size is one where the blend radius is relative to the radii of the lattice balls.

1. A computer-implemented method of generating a model of a component from a blended lattice, wherein the blended lattice comprises a plurality of lattice topologies joined together, the method comprising:
dividing a volume containing an input lattice into a plurality of cubes, each cube forming a voxel of side length v;
evaluating h(p) uniformly over the volume for each value of a position p occurring at a corner of a cube, wherein h(p) is a piecewise scalar field function for a blended lattice, wherein a surface of an unblended lattice is defined by a field function ƒ(p) and a surface of a blended lattice is defined by a field function g(p), wherein away from any blends ƒ(p)=0 and g(p)=0 are a same iso-surface, and wherein the value of h(p) at a position p, wherein for two closest lattice topologies i₁, i₂ of the plurality of lattice topologies, ƒ₁(p) and ƒ₂(p) satisfy ƒ₁(p)≤ƒ₂(p), is given by:
h(p)=ƒ(p) if ƒ₁(p)≤−v;
h(p)=ƒ(p) if ƒ₂(p)≥2r+v;
h(p)=ƒ(p) if ƒ₁(p)+ƒ₂(p)≥2r and ƒ₁(p)≥v; and
h(p)=g(p) otherwise,
where r is a blend radius; and
generating a model of a component comprising a blended lattice with the scalar field function h(p).

2. The computer-implemented method of claim 1, wherein each lattice topology i of the plurality of lattice topologies is a rod or a ball.

3. The computer-implemented method of claim 1, wherein the field function of the unblended lattice ƒ(p) is given by:
$$f ( p ) = {min}_{1 \leq i \leq N} {f}_{i} ( p )$$
where ƒᵢ(p) is a signed distance from the position p to a surface of a lattice topology i, and N is a number of lattice topologies in the blended lattice, and
wherein the field function of the blended lattice g(p) is given by:
$$g ( p ) = {max}_{‖ q - p ‖ \leq r} ( f ( q ) - r )$$
where q is a position within a volume of a sphere of radius r centered at p.

4. The computer-implemented method of claim 3, wherein an evaluation of:
$$f ( p ) = {min}_{1 \leq i \leq N} {f}_{i} ( p )$$
is stopped at a value of i where ƒᵢ(p)≤−v, and
wherein an evaluation of:
$$g ( p ) = {max}_{‖ q - p ‖ \leq r} ( f ( q ) - r )$$
is stopped at a value of q where ƒ(q)−r≥v.

5. The computer-implemented method of claim 4, wherein, when the value of h(p′) has already been calculated at a position p′, the value of h(p) is set to a lower bound:
h_{lower}=h(p′)−∥p−p′∥, when h_{lower}≥v,
or to an upper bound:
hᵤₚₚₑᵣ=h(p′)+∥p−p′∥, when hᵤₚₚₑᵣ≤−v.

6. The computer-implemented method of claim 3, wherein the field function of the blended lattice g(p) and the corresponding position q are determined exactly.

7. The computer-implemented method of claim 3, wherein the field function of the blended lattice g(p) and the corresponding position q are estimated.

8. The computer-implemented method as of claim 3, wherein the field function of the blended lattice g(p) and the corresponding position q are determined using sampling of the sphere.

9. The computer-implemented method of claim 1, wherein the blend radius r is constant over a lattice structure.

10. The computer-implemented method of claim 1, wherein the blend radius r is a function of the position p.

11. The computer-implemented method of claim 1, further comprising:
incarnating the blended lattice as a mesh surface prior to generate the model of the component.

12. The computer-implemented method of claim 1, further comprising:
exporting the model of the component to an additive manufacturing device and manufacturing the component.

13. A data processing system configured to generate a model of a component from a blended lattice, wherein the blended lattice comprises a plurality of lattice topologies joined together, the data processing system comprising:
a processor configured to:
divide a volume of an input lattice into a plurality of cubes, each cube forming a voxel of side length v;
evaluate h(p) uniformly over the volume for each value of a position p occurring at a corner of a cube, wherein h(p) is a piecewise scalar field function for a blended lattice; wherein a surface of an unblended lattice is defined by the field function ƒ(p) and a surface of a blended lattice is defined by a field function g(p), wherein away from any blends ƒ(p)=0 and g(p)=0 are a same iso-surface, and wherein the value of h(p) at a position p, wherein for two closest lattice topologies i₁, i₂ of the plurality of lattice topologies, ƒ₁(p) and ƒ₂(p) satisfy ƒ₁(p)≤ƒ₂(p), is given by:
h(p)=ƒ(p) if ƒ₁(p)≤−v;
h(p)=ƒ(p) if ƒ₂(p)≥2r+v;
h(p)=ƒ(p) if ƒ₁(p)+ƒ₂(p)≥2r and ƒ₁(p)≥v; and
h(p)=g(p) otherwise,
where r is a blend radius; and
generate a model of a component comprising a blended lattice with the scalar field function h(p).

14. The data processing system of claim 13, further comprising:
an output to a three-dimensional printing device.

15. A computer program, which, when executed on a computer, causes the computer to:
divide a volume containing an input lattice into a plurality of cubes, each cube forming a voxel of side length v;
evaluate h(p) uniformly over the volume for each value of a position p occurring at a corner of a cube, wherein h(p) is a piecewise scalar field function for a blended lattice, wherein a surface of an unblended lattice is defined by a field function ƒ(p) and a surface of a blended lattice is defined by a field function g(p), wherein away from any blends ƒ(p)=0 and g(p)=0 are a same iso-surface, and wherein the value of h(p) at a position p, wherein for two closest lattice topologies i, is of a plurality of lattice topologies, ƒ₁(p) and ƒ₂(p) satisfy ƒ₁(p)≤ƒ₂ (p), is given by:
h(p)=ƒ(p) if ƒ₁(p)≤−v;
h(p)=ƒ(p) if ƒ₂(p)≥2r+v;
h(p)=ƒ(p) if ƒ₁(p)+ƒ₂(p)≥2r and ƒ₁(p)≥v; and
h(p)=g(p) otherwise,
where r is a blend radius; and
generate a model of a component comprising a blended lattice with the scalar field function h(p).
